(19) United States
(12) Patent Application Publication
(10) Pub. No.: US 2024/0021854 A1
(43) Pub. Date: Jan. 18, 2024

(54) HYDROGEN SUPPLY SYSTEM FOR FUEL CELL AND CONTROL METHOD THEREOF

(71) Applicants: HYUNDAI MOTOR COMPANY, Seoul (KR); KIA CORPORATION, Seoul (KR)

(72) Inventors: Jun Young Park, Suwon-si (KR); Dong Chun Lee, Yongin-si (KR); Jai Hyun Ahn, Seoul (KR); Ji Hee Jun, Yongin-si (KR)

(21) Appl. No.: 18/099,045

(22) Filed: Jan. 19, 2023

(30) Foreign Application Priority Data
Jul. 18, 2022 (KR) 10-2022-0088446

(51) Int. Cl. H01M 8/0438; H01M 8/04746; H01M 8/04082; H01M 8/04303

(52) U.S. Cl. CPC H01M 8/04432; H01M 8/04388; H01M 8/04761; H01M 8/04201; H01M 8/04303

(57) ABSTRACT

A hydrogen supply system for a fuel cell includes a fuel cell, a hydrogen supply line connected to an inlet side of a fuel-cell anode, and supplying hydrogen to the fuel cell, a pressure sensor provided on the hydrogen supply line, and measuring a pressure of the hydrogen supply line, a discharge line connected to an outlet side of the fuel-cell anode, and communicating with the outside; a discharge valve provided on the discharge line to control communication between the anode of the fuel cell and the outside, and a controller shutting off the discharge valve during an operation of the fuel cell, differently estimating an amount of gas discharged through the discharge line depending on whether choking occurs after the discharge valve is shut off, and correcting the pressure sensor based on the estimated gas discharge amount.

### CROSS REFERENCE TO RELATED APPLICATIONS

The present application claims priority to Korean Patent Application No. 10-2022-0088446, filed Jul. 18, 2022, the entire contents of which are incorporated herein for all purposes by this reference.

### BACKGROUND

### Field of the Disclosure

The present disclosure relates to a hydrogen supply system for a fuel cell and a control method thereof, in which a pressure sensor is corrected based on a gas discharge amount that is differently estimated depending on whether choking occurs after a discharge valve is shut off during the operation of the fuel cell.

### Description of the Related Art

A fuel cell system includes a hydrogen supply system, an air supply system, and a fuel cell that produces electric energy using a chemical reaction between supplied hydrogen and oxygen.

A hydrogen supply system for supplying the hydrogen to the fuel cell includes a hydrogen supply line that is connected to an anode side of the fuel cell to supply the hydrogen to the fuel cell and recirculate the hydrogen. The hydrogen supply system further includes a hydrogen storage tank in which high-pressure hydrogen is stored, a hydrogen supply valve which supplies the hydrogen of the hydrogen storage tank to the hydrogen supply line, and a discharge line which discharges impurities and condensate present in a fuel-cell anode to the outside.

The hydrogen supply valve supplies the hydrogen of the hydrogen storage tank to the hydrogen supply line according to the generated current, temperature, and pressure of the fuel cell. The hydrogen supply line is provided with a pressure sensor that measures the pressure of the hydrogen supply line, and the sensing value of the pressure sensor is used to control the opening of the hydrogen supply valve. However, an offset frequently occurs in the sensing value of the pressure sensor, and the offset occurs in the pressure sensor, so the pressure of the hydrogen supply line is not precisely controlled.

Conventionally, in the case of satisfying a pressure-sensor correcting condition when a fuel cell system is shut down, the fuel cell communicates with the outside by opening a discharge valve provided on the discharge line. In the state where the fuel cell communicates with the outside, the offset of the pressure sensor is calculated based on a difference in measured value between the pressure sensor and the atmospheric-pressure sensor. Subsequently, the pressure sensor is corrected based on the calculated offset of the pressure sensor. However, when the pressure sensor is corrected, the fuel cell communicates with the outside, so hydrogen in the fuel cell is unintentionally discharged to the outside.

The foregoing is intended merely to aid in the understanding of the background of the present disclosure, and is not intended to mean that the present disclosure falls within the purview of the related art that is already known to those skilled in the art.

### SUMMARY

Accordingly, the present disclosure has been made keeping in mind the above problems occurring in the related art, and an objective of the present disclosure is to provide a hydrogen supply system for a fuel cell and a control method thereof, in which a pressure sensor is corrected based on a gas discharge amount that is differently estimated depending on whether choking occurs after a discharge valve is shut off during the operation of the fuel cell.

In order to achieve the objective of the present disclosure, the present disclosure provides a hydrogen supply system for a fuel cell, the system including the fuel cell, a hydrogen supply line connected to an inlet side of a fuel-cell anode, and supplying hydrogen to the fuel cell, a pressure sensor provided on the hydrogen supply line, and measuring a pressure of the hydrogen supply line; a discharge line connected to an outlet side of the fuel-cell anode, and communicating with an outside, a discharge valve provided on the discharge line to control communication between the fuel-cell anode and the outside, and a controller shutting off the discharge valve during an operation of the fuel cell, differently estimating an amount of gas discharged through the discharge line depending on whether choking occurs after the discharge valve is shut off, and correcting the pressure sensor based on the estimated gas discharge amount.

The controller may correct the pressure sensor based on atmospheric pressure in a state where the fuel cell communicates with the outside by opening the discharge valve before the discharge valve is shut off.

The pressure sensor may include a hydrogen nozzle-pressure sensor and a hydrogen low-pressure sensor, the hydrogen nozzle-pressure sensor may be located at an upstream point of an ejector provided on the hydrogen supply line, and the hydrogen low-pressure sensor may be located at a downstream point of the ejector provided on the hydrogen supply line.

The controller may calculate a difference between pressures measured through the hydrogen nozzle-pressure sensor and the hydrogen low-pressure sensor, may determine that choking occurs when the calculated difference is larger than a reference value, and may determine that no choking occurs when the calculated difference is smaller than the reference value.

The controller may calculate a hydrogen supply amount based on pressure measured by the hydrogen nozzle-pressure sensor when the choking occurs, may calculate a hydrogen supply amount based on pressure measured by the hydrogen nozzle-pressure sensor and the hydrogen low-pressure sensor when no choking occurs, and may estimate a gas discharge amount using the calculated hydrogen supply amount.

When the gas discharge amount is estimated and then the pressure sensor corrected based on the atmospheric pressure maintains a normal state, the controller may calculate an average value of the estimated gas discharge amount while the normal state is maintained and then may store the average value in a memory.

The normal state of the pressure sensor may be an initial state where no error occurs in a measured value of the pressure sensor after the pressure sensor is corrected.

The controller may calculate a difference in average value between the estimated gas discharge amount when the pressure sensor, corrected based on the atmospheric pressure after the gas discharge amount is estimated, is not maintained in the normal state and the stored gas discharge amount in the normal state.

The controller may calculate a correction value of the hydrogen nozzle-pressure sensor based on a calculated difference in average value between the estimated gas discharge amount when choking occurs and the stored gas discharge amount, and may correct the hydrogen nozzle-pressure sensor through the calculated correction value.

The controller may calculate the correction value of the hydrogen low-pressure sensor based on a calculated difference in average value between the estimated gas discharge amount when no choking occurs and the stored gas discharge amount and a pressure measured by the hydrogen nozzle-pressure sensor, and may correct the hydrogen low-pressure sensor through the calculated correction value.

In order to achieve the objective of the present disclosure, the present disclosure provides a method of controlling a hydrogen supply system for a fuel cell, the method including shutting off a discharge valve during an operation of the fuel cell by a controller, differently estimating a gas discharge amount discharged through a discharge line depending on whether choking occurs after the discharge valve is shut off by the controller; and correcting a pressure sensor based on the estimated gas discharge amount depending on whether choking occurs by the controller.

In the differently estimating the gas discharge amount, the controller may calculate a difference between pressure measured by the hydrogen nozzle-pressure sensor and pressure measured by the hydrogen low-pressure sensor, may determine that choking occurs when the calculated difference is larger than a reference value, and may determine that no choking occurs when the calculated difference is smaller than the reference value.

In the differently estimating the gas discharge amount, the controller may calculate a hydrogen supply amount based on pressure measured by the hydrogen nozzle-pressure sensor when choking occurs, may calculate the hydrogen supply amount based on the pressure measured by the hydrogen nozzle-pressure sensor and the hydrogen low-pressure sensor when no choking occurs, and may estimate the gas discharge amount using the calculated hydrogen supply amount.

In the correcting the pressure sensor, the controller may calculate the correction value of the hydrogen nozzle-pressure sensor to correct the hydrogen nozzle-pressure sensor, when choking occurs.

In the correcting the pressure sensor, the controller may calculate the correction value of the hydrogen low-pressure sensor to correct the hydrogen low-pressure sensor, when no choking occurs.

A hydrogen supply system for a fuel cell and a control method thereof according to the present disclosure are advantageous in that a pressure sensor is corrected based on an estimated gas discharge amount after a discharge valve is shut off during the operation of the fuel cell, thus preventing the concentration of hydrogen from being reduced due to the communication of the fuel cell with the outside, and preventing the fuel cell from being deteriorated.

Further, the present disclosure is advantageous in that a pressure sensor is corrected based on a gas discharge amount that is differently estimated depending on whether choking occurs after a discharge valve is shut off, thus preventing the hydrogen concentration of a fuel cell from being excessively increased or reduced due to the measurement error of the pressure sensor.

### BRIEF DESCRIPTION OF THE FIGURES

The above and other objectives, features, and other advantages of the present disclosure will be more clearly understood from the following detailed description when taken in conjunction with the accompanying drawings, in which:

FIG. 1 is a diagram illustrating the configuration of a hydrogen supply system for a fuel cell according to an embodiment of the present disclosure.

FIG. 2 is a graph illustrating a change in a hydrogen nozzle-pressure sensor as a function of the flow rate of hydrogen supplied to the hydrogen supply system for the fuel cell according to an embodiment of the present disclosure.

FIG. 3 is a graph illustrating a change in a hydrogen low-pressure sensor as a function of the flow rate of hydrogen supplied to the hydrogen supply system for the fuel cell according to an embodiment of the present disclosure.

FIG. 4 is a flowchart illustrating a control method of a hydrogen supply system for a fuel cell, according to an embodiment of the present disclosure.

### DETAILED DESCRIPTION

When it is determined that the detailed description of the known art related to the present disclosure may be obscure the gist of the disclosure, the detailed description thereof will be omitted. Further, it is to be understood that the accompanying drawings are merely for making those skilled in the art easily understand embodiments disclosed herein, and the present disclosure is intended to cover not only exemplary embodiments disclosed herein, but also various alternatives, modifications, equivalents and other embodiments that fall within the spirit and scope of the present disclosure.

It will be understood that, although the terms “first”, “second”, etc. may be used herein to describe various elements, these elements should not be limited by these terms. These terms are only used to distinguish one element from another element.

It will be understood that when an element is referred to as being “coupled” or “connected” to another element, it can be directly coupled or connected to the other element or intervening elements may be present therebetween. In contrast, it should be understood that when an element is referred to as being “directly coupled” or “directly connected” to another element, there are no intervening elements present.

Herein, the singular forms are intended to include the plural forms as well, unless the context clearly indicates otherwise.

It will be further understood that the terms “comprise”, “include”, “have”, etc. when used in this specification, specify the presence of stated features, integers, steps, operations, elements, components, and/or combinations thereof but do not preclude the presence or addition of one or more other features, integers, steps, operations, elements, components, and/or combinations thereof.

Hereinafter, the present disclosure will be explained in detail by describing exemplary embodiments of the present disclosure with reference to the accompanying drawings. The same reference numerals are used throughout the drawings to designate the same or similar components.

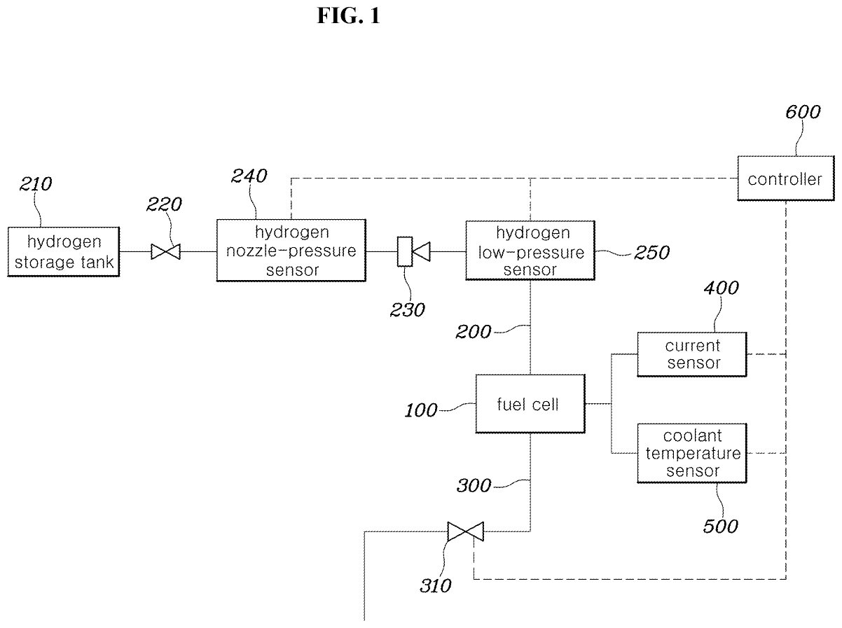

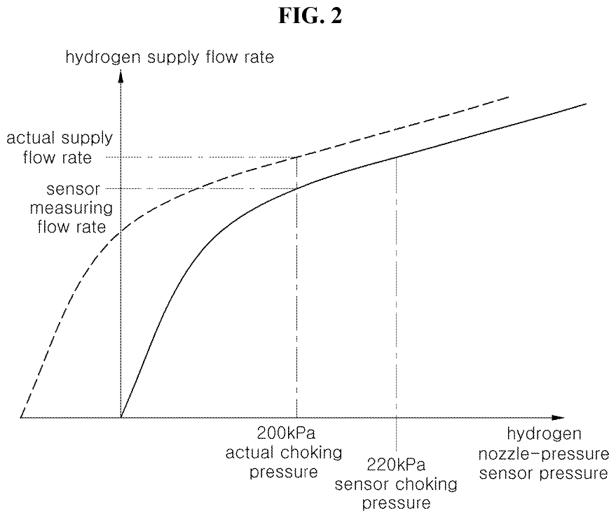

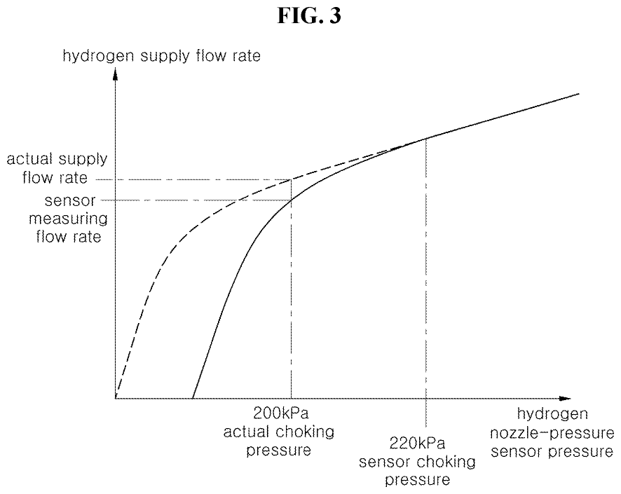

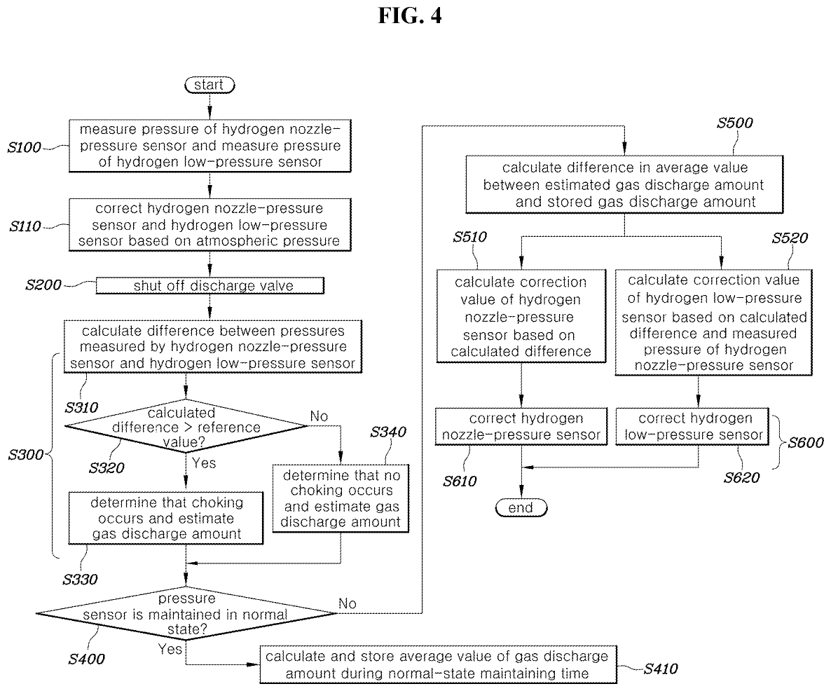

FIG. 1 is a diagram illustrating the configuration of a hydrogen supply system for a fuel cell according to an embodiment of the present disclosure, FIG. 2 is a graph illustrating a change in a hydrogen nozzle-pressure sensor as a function of the flow rate of hydrogen supplied to the hydrogen supply system for the fuel cell according to an embodiment of the present disclosure, FIG. 3 is a graph illustrating a change in a hydrogen low-pressure sensor as a function of the flow rate of hydrogen supplied to the hydrogen supply system for the fuel cell according to an embodiment of the present disclosure, and FIG. 4 is a flowchart illustrating a control method of a hydrogen supply system for a fuel cell, according to an embodiment of the present disclosure.

FIG. 1 is a diagram illustrating the configuration of a hydrogen supply system for a fuel cell according to an embodiment of the present disclosure. The hydrogen supply system for a fuel cell 100 according to the present disclosure includes a fuel cell 100, a hydrogen supply line 200 that is connected to an inlet side of a fuel-cell anode and supplies hydrogen to the fuel cell 100, pressure sensors 240 and 250 that are provided on the hydrogen supply line 200 and measure the pressure of the hydrogen supply line 200, a discharge line 300 that is connected to an outlet side of the fuel-cell anode and communicates with the outside, a discharge valve 310 that is provided on the discharge line 300 to control communication between the anode of the fuel cell 100 and the outside, and a controller 600 that shuts off the discharge valve 310 during the operation of the fuel cell 100, differently estimates the amount of gas discharged through the discharge line 300 depending on whether choking occurs after the discharge valve 310 is shut off, and corrects the pressure sensors 240 and 250 based on the estimated gas discharge amount.

The controller 600 according to an exemplary embodiment of the present disclosure may be implemented through a non-volatile memory (not shown) configured to store data about an algorithm configured to control the operation of various components of a vehicle or a software instruction for reproducing the algorithm, and a processor (not shown) configured to perform an operation, which will be described below, using the data stored in the memory. In this regard, the memory and the processor may be implemented as separate chips. Alternatively, the memory and the processor may be implemented as a single integrated chip, and the processor may take the form of one or more processors.

The hydrogen supply system for the fuel cell 100 includes the fuel cell 100 and the hydrogen supply line 200 that supplies hydrogen to the fuel cell 100. The hydrogen supply line 200 further includes a hydrogen storage tank 210 that stores high-pressure hydrogen, a hydrogen supply valve 220 that supplies high-pressure hydrogen stored in the hydrogen storage tank 210 to the hydrogen supply line 200, and pressure sensors 240 and 250 that measure the pressure of the hydrogen supply line 200. In particular, the pressure sensors 240 and 250 generate a measurement error when the pressure of the hydrogen supply line 200 is measured, so a pressure less or more than a target pressure may be supplied to the fuel cell 100 due to the generated error.

In order to solve the problem, the pressure sensors 240 and 250 of the fuel cell 100 are corrected to atmospheric pressure by opening the discharge valve 310. The discharge line 300 is connected to the outlet side of the fuel-cell anode to discharge impurities or condensate generated in the fuel-cell anode to the outside, and the discharge valve 310 is provided on the discharge line 300 to control communication between the anode of the fuel cell 100 and the outside. By opening the discharge valve 310, the anode of the fuel cell 100 communicates with the outside, and pressure values are measured through the pressure sensors 240 and 250 and the atmospheric-pressure sensor while the fuel cell communicating with the outside. Subsequently, the pressure sensors 240 and 250 are corrected based on a difference between pressure values measured through the pressure sensors 240 and 250 and the atmospheric-pressure sensor. However, when the pressure sensors 240 and 250 are corrected by making the fuel cell 100 communicate with the outside, it is necessary to depressurize the fuel-cell anode to an atmospheric-pressure level, and the hydrogen of the fuel-cell anode may be discharged to the outside due to the depressurization to the atmospheric-pressure level. When the hydrogen of the fuel-cell anode is discharged to the outside, the hydrogen concentration of the fuel-cell anode may be reduced, and the fuel cell 100 may be deteriorated due to a reduction in hydrogen concentration. Therefore, according to the present disclosure, the pressure sensors 240 and 250 are corrected in a state where the fuel cell 100 does not communicate with the outside by closing the discharge valve 310, thus preventing the fuel cell 100 from being deteriorated due to a reduction in hydrogen concentration.

First, the controller 600 corrects the pressure sensors 240 and 250 based on atmospheric pressure in a state where the fuel cell 100 communicates with the outside by opening the discharge valve 310 before the discharge valve 310 is shut off. The controller 600 causes the fuel cell 100 to communicate with the outside by opening the discharge valve 310, and measures the pressure of the fuel cell 100 while the fuel cell communicates with the outside. The controller 600 corrects the pressure sensors 240 and 250 based on a difference between the atmospheric pressure and the measured pressure in the state where the fuel cell communicates with the outside.

The pressure sensors 240 and 250 include the hydrogen nozzle-pressure sensor 240 and the hydrogen low-pressure sensor 250. The hydrogen nozzle-pressure sensor 240 is located at an upstream point of an ejector 230 provided on the hydrogen supply line 200, and the hydrogen low-pressure sensor 250 is located at a downstream point of the ejector 230 provided on the hydrogen supply line 200. The pressure sensors 240 and 250, which are to be corrected in the present disclosure, are the hydrogen nozzle-pressure sensor 240 and the hydrogen low-pressure sensor 250. The positions of the hydrogen nozzle-pressure sensor 240 and the hydrogen low-pressure sensor 250 are determined by the ejector 230 provided on the hydrogen supply line 200.

The controller 600 corrects the hydrogen nozzle-pressure sensor 240 and the hydrogen low-pressure sensor 250 based on the atmospheric pressure and then shuts off the discharge valve 310. Further, the controller 600 estimates the amount of gas discharged through the discharge line 300 after shutting off the discharge valve 310, and corrects the pressure sensors 240 and 250 based on the estimated gas discharge amount. Even if the hydrogen nozzle-pressure sensor 240 and the hydrogen low-pressure sensor 250 are corrected based on the atmospheric pressure, an error may occur again in the measured value of the sensor over time. When the error occurs again, it is necessary to make the fuel cell 100 communicate with the outside so as to correct the pressure sensors 240 and 250 based on the atmospheric pressure. Because the fuel cell 100 communicates with the outside, the hydrogen of the fuel cell 100 is discharged to the outside, thus causing the waste of the hydrogen and a reduction in the hydrogen concentration of the fuel cell 100. Therefore, by shutting off the discharge valve 310 when the hydrogen nozzle-pressure sensor 240 and the hydrogen low-pressure sensor 250 are corrected based on the atmospheric pressure and then the measurement error occurs, the hydrogen nozzle-pressure sensor 240 and the hydrogen low-pressure sensor 250 may be corrected without wasting hydrogen.

The controller 600 shuts off the discharge valve 310, and checks whether choking occurs through pressures measured in the hydrogen nozzle-pressure sensor 240 and the hydrogen low-pressure sensor. The controller 600 calculates a difference between pressures measured through the hydrogen nozzle-pressure sensor 240 and the hydrogen low-pressure sensor 250, determines that choking occurs if the calculated difference is larger than a reference value, and determines that no choking occurs if the calculated difference is smaller than the reference value. The controller 600 measures the pressure of the hydrogen supply line 200 through the hydrogen nozzle-pressure sensor 240 and the hydrogen low-pressure sensor 250. Further, the controller 600 calculates a difference between pressures measured through the hydrogen nozzle-pressure sensor 240 and the hydrogen low-pressure sensor 250, and compares the calculated difference with the reference value. When the calculated difference is larger than the reference value, the controller 600 determines that choking occurs. When the calculated difference is smaller than the reference value, the controller 600 determines that no choking occurs.

The choking means a phenomenon in which hydrogen supplied through the hydrogen supply line 200 is generated upstream of the ejector 230 while a flow velocity approaches a sound velocity. In the present disclosure, the controller 600 checks whether the choking phenomenon occurs based on the pressure measured by the hydrogen nozzle-pressure sensor 240 and the hydrogen low-pressure sensor 250. When the choking occurs, no change occurs in the measured pressure of the hydrogen low-pressure sensor 250 even if a change occurs in the measured pressure of the hydrogen nozzle-pressure sensor 240. After the choking occurs, the hydrogen low-pressure sensor 250 measures the same pressure as pressure measured when the choking occurs.

The controller 600 calculates a hydrogen supply amount based on pressure measured by the hydrogen nozzle-pressure sensor 240 when the choking occurs, and calculates a hydrogen supply amount based on pressure measured by the hydrogen nozzle-pressure sensor 240 and the hydrogen low-pressure sensor 250 when no choking occurs. Subsequently, the controller 600 estimates a gas discharge amount using the calculated hydrogen supply amount. The gas discharge amount may be estimated by calculating a hydrogen supply amount supplied to the fuel cell 100, a hydrogen consumption amount consumed in the fuel cell 100, and a gas residual amount remaining in the fuel cell 100. The hydrogen supply amount is differently calculated depending on whether choking occurs.

Even if there is a change in the measured pressure of the hydrogen nozzle-pressure sensor 240 when choking occurs, the measured pressure of the hydrogen low-pressure sensor 250 is kept constant. Therefore, the controller 600 needs to calculate the hydrogen supply amount based on the pressure measured by the hydrogen nozzle-pressure sensor 240 when choking occurs. At this time, the controller 600 calculates a hydrogen supply amount based on the pressure measured by the hydrogen nozzle-pressure sensor 240 using a separately provided flow-rate conversion equation. If there is a change in the measured pressure of the hydrogen nozzle-pressure sensor 240 when no choking occurs, the measured pressure of the hydrogen low-pressure sensor 250 is also changed. Thus, the controller 600 needs to calculate the hydrogen supply amount based on pressure measured by the hydrogen nozzle-pressure sensor 240 and the hydrogen low-pressure sensor 250 when no choking occurs. At this time, the controller 600 is provided with a separate flow-rate conversion map to calculate the hydrogen supply amount based on the pressure measured by the hydrogen nozzle-pressure sensor 240 and the hydrogen low-pressure sensor 250.

Further, the controller 600 measures the generated current of the fuel cell 100 through the current sensor 400, and calculates the hydrogen consumption amount based on the measured generated current. Referring to the prior art, the hydrogen consumption amount consumed in the fuel cell 100 per minute may be calculated through the following Equation 1.

Hydrogen consumption amount per minute=(stack current*number of stack cell*R*Tₛ*60)/(2*F) Equation 1:

where R represents an ideal gas constant, Tₛ represents an absolute temperature corresponding to 0° C., and F represents a Faraday constant. The stack current means the generated current of the fuel cell 100 measured by the current sensor 400, and the number of stack cells means the number of cells forming the fuel cell 100. The controller 600 may calculate the hydrogen consumption amount consumed in the fuel cell 100 through the above Equation 1.

Further, the controller 600 measures a coolant temperature on the outlet side of the fuel cell 100 through a coolant temperature sensor 500, and calculates a gas residual amount based on the measured coolant temperature and a pressure change amount measured by the hydrogen low-pressure sensor 250. Referring to the prior art, the gas residual amount remaining in the fuel cell 100 may be calculated through the following Equation 2.

Gas residual amount=(anode pressure change amount*anode volume*Tₛ)/(stack temperature*Pₛ) Equation 2:

where Tₛ represents an absolute temperature corresponding to 0° C., and Pₛ is 100 kPa. The anode pressure change amount represents the pressure change amount of the fuel cell 100 measured by the hydrogen low-pressure sensor 250, and the stack temperature represents the temperature of the fuel cell 100 measured through the coolant temperature sensor 500. The controller 600 may calculate the gas residual amount remaining in the fuel cell 100 through the above Equation 2. Therefore, the controller 600 may estimate the gas discharge amount based on the hydrogen supply amount, the hydrogen consumption amount, and the gas residual amount. Further, depending on whether the choking occurs, the controller 600 may differently calculate the hydrogen supply amount, and may differently estimate the gas discharge amount by differently calculating the hydrogen supply amount.

When the gas discharge amount is estimated and then the pressure sensors 240 and 250 corrected based on the atmospheric pressure maintain a normal state, the controller 600 calculates the average value of the estimated gas discharge amount while the normal state is maintained and then stores the average value in a memory.

FIG. 2 is a graph illustrating a change in the hydrogen nozzle-pressure sensor as a function of the flow rate of hydrogen supplied to the hydrogen supply system for the fuel cell according to an embodiment of the present disclosure, and FIG. 3 is a graph illustrating a change in the hydrogen low-pressure sensor as a function of the flow rate of hydrogen supplied to the hydrogen supply system for the fuel cell according to an embodiment of the present disclosure. The solid lines in the graphs of FIGS. 2 and 3 mean flow rates measured by the hydrogen nozzle-pressure sensor 240 and the hydrogen low-pressure sensor 250, and the dotted lines mean a flow rate that is actually supplied through the hydrogen supply line 200. According to an embodiment, the controller 600 determines that choking occurs when the pressure measured by the hydrogen nozzle-pressure sensor 240 is more than twice the pressure measured by the hydrogen low-pressure sensor 250. If the pressure measured by the hydrogen low-pressure sensor 250 is 110 kPa and the pressure measured by the hydrogen nozzle-pressure sensor 240 is more than 220 kPa based on the pressure measured by the sensor, choking occurs. Referring to FIG. 2, if the pressure measured by the hydrogen nozzle-pressure sensor 240 is 220 kPa but the actually supplied pressure is 200 kPa, the hydrogen nozzle-pressure sensor 240 has the error of 20 kPa. Thus, the pressure at which the hydrogen nozzle-pressure sensor 240 detects the occurrence of choking is 220 kPa, but choking actually occurs at the pressure of 200 kPa. Due to the error occurrence of the hydrogen nozzle-pressure sensor 240, an excessive amount of hydrogen may be supplied to the fuel cell 100.

Further, referring to FIG. 3, if the pressure measured by the hydrogen low-pressure sensor 250 is 110 kPa and pressure on the actual fuel cell 100 is 100 kPa, the hydrogen low-pressure sensor 250 has the error of 10 kPa. Further, if the measured pressure of the hydrogen nozzle-pressure sensor 240 is 200 kPa, a differential pressure between the hydrogen nozzle-pressure sensor 240 and the hydrogen low-pressure sensor 250 becomes 90 kPa based on the measured value. However, the actual differential pressure is 100 kPa, thus causing an error in the measured value. If it is determined that choking occurs when the hydrogen nozzle-pressure sensor 240 is more than twice the hydrogen low-pressure sensor 250, the controller 600 determines that the choking occurs when the pressure of 220 kPa is measured by the hydrogen nozzle-pressure sensor 240. However, since the actual pressure of the hydrogen low-pressure sensor 250 is 100 kPa, it can be checked that choking already occurs at 200 kPa. That is, when there occur errors in the hydrogen nozzle-pressure sensor 240 and the hydrogen low-pressure sensor 250, an excessive or insufficient amount of hydrogen may be supplied to the fuel cell 100, which leads to an error when calculating the hydrogen supply amount for estimating the gas discharge amount.

Thus, the controller 600 corrects the hydrogen nozzle-pressure sensor 240 and the hydrogen low-pressure sensor 250 based on the atmospheric pressure, and checks whether the corrected hydrogen nozzle-pressure sensor 240 and hydrogen low-pressure sensor 250 are maintained in a normal state. The normal state of the pressure sensors 240 and 250 means an initial state where no error occurs in the measured values of the pressure sensors 240 and 250 after the pressure sensors 240 and 250 are corrected. The controller 600 needs to estimate a gas discharge amount during a normal state when the hydrogen nozzle-pressure sensor 240 and the hydrogen low-pressure sensor 250 are maintained in the normal state, calculate the average value of the estimated gas discharge amount, and then store the average value. The controller 600 may provide a standard for correcting the error when there occurs the error in the pressure sensors 240 and 250 by calculating and storing the average value of the estimated gas discharge amount while the pressure sensors 240 and 250 are maintained in the normal state. At this time, the average value of the gas discharge amount may be differently calculated depending on whether choking occurs or not, and the controller 600 may store the calculated average value of the gas discharge amount depending on whether choking occurs or not.

The controller 600 calculates a difference in average value between the estimated gas discharge amount when the pressure sensors 240 and 250, corrected based on the atmospheric pressure after the gas discharge amount is estimated, are not maintained in the normal state and the stored gas discharge amount in the normal state. Unless the hydrogen nozzle-pressure sensor 240 and the hydrogen low-pressure sensor 250 corrected based on the atmospheric pressure are maintained in the normal state, a measurement error occurs in the hydrogen nozzle-pressure sensor 240 and the hydrogen low-pressure sensor 250. In order to correct the error occurring in the hydrogen nozzle-pressure sensor 240 and the hydrogen low-pressure sensor 250, the controller 600 estimates the gas discharge amount when the pressure sensors 240 and 250 are not in the normal state. A process of estimating the gas discharge amount is performed again using the error occurring in the hydrogen nozzle-pressure sensor 240 and the hydrogen low-pressure sensor 250. The controller 600 calculates a difference in pressure measured by the hydrogen nozzle-pressure sensor 240 and the hydrogen low-pressure sensor 250, and determines that choking occurs when the calculated difference is larger than the reference value, and no choking occurs when the calculated difference is smaller than the reference value. The controller 600 estimates the gas discharge amount for a case where choking occurs and a case where no choking occurs. Subsequently, the controller 600 calculates a difference in average value between the gas discharge amounts estimated depending on whether choking occurs or not when the hydrogen nozzle-pressure sensor 240 and the hydrogen low-pressure sensor 250 are not maintained in the normal state and the gas discharge amount in the normal state. The controller 600 may correct the error occurring in the pressure sensor by calculating the difference between the normal state and the abnormal state.

To be more specific, the controller 600 calculates the correction value of the hydrogen nozzle-pressure sensor 240 based on a calculated difference in average value between the estimated gas discharge amount when choking occurs and the stored gas discharge amount, and corrects the hydrogen nozzle-pressure sensor 240 through the calculated correction value. Even if the measured pressure of the hydrogen nozzle-pressure sensor 240 is changed when choking occurs, the measured pressure of the hydrogen low-pressure sensor 250 is not changed. Thus, the controller 600 needs to correct only the hydrogen nozzle-pressure sensor 240 when choking occurs. The controller 600 calculates a pressure error occurring in the hydrogen nozzle-pressure sensor 240 based on a calculated difference in average value between the estimated gas discharge amount when the hydrogen nozzle-pressure sensor 240 and the hydrogen low-pressure sensor 250 are not maintained in the normal state and the stored gas discharge amount in the normal state. The calculated pressure error is calculated as a correction value for correcting the measurement error of the hydrogen nozzle-pressure sensor 240, and the controller 600 corrects the hydrogen nozzle-pressure sensor 240 through the calculated correction value.

Further, the controller 600 calculates the correction value of the hydrogen low-pressure sensor 250 based on a calculated difference in average value between the estimated gas discharge amount when no choking occurs and the stored gas discharge amount and a pressure measured by the hydrogen nozzle-pressure sensor 240, and corrects the hydrogen low-pressure sensor 250 through the calculated correction value. When no choking occurs, a change in pressure measured by the hydrogen nozzle-pressure sensor 240 leads to a change in pressure measured by the hydrogen low-pressure sensor 250. Thus, the controller 600 needs to consider the hydrogen nozzle-pressure sensor 240 when correcting the hydrogen low-pressure sensor 250. The controller 600 calculates a pressure error occurring in the hydrogen low-pressure sensor 250 based on a calculated difference in average value between the estimated gas discharge amount when the hydrogen nozzle-pressure sensor 240 and the hydrogen low-pressure sensor 250 are not maintained in the normal state and the stored gas discharge amount in the normal state and a pressure measured by the hydrogen nozzle-pressure sensor 240. The calculated pressure error is calculated as a correction value for correcting the measurement error of the hydrogen low-pressure sensor 250, and the controller 600 corrects the hydrogen low-pressure sensor 250 through the calculated correction value. Therefore, the controller 600 prevents the fuel cell 100 from communicating with the outside and corrects the pressure sensors 240 and 250 based on the gas change amount occurring in the fuel cell 100, thus preventing the unnecessary waste of hydrogen.

Meanwhile, FIG. 4 is a flowchart illustrating a control method of a hydrogen supply system for a fuel cell, according to an embodiment of the present disclosure. The control method of the hydrogen supply system for the fuel cell 100 according to the present disclosure includes a step S200 of shutting off the discharge valve 310 during the operation of the fuel cell 100 by the controller 600, a step S300 of differently estimating a gas discharge amount discharged through the discharge line 300 depending on whether choking occurs or not after the discharge valve 310 is shut off by the controller 600; and a step S600 of correcting the pressure sensors 240 and 250 based on the estimated gas discharge amount depending on whether choking occurs or not by the controller 600.

The controller 600 measures the pressure of the hydrogen supply line 200 through the pressure sensors 240 and 250 before the discharge valve 310 is shut off at S100. The pressure sensors 240 and 250 generate an error in a measured value over time, and the controller 600 makes the fuel cell 100 communicate with the outside by opening the discharge valve 310 so as to correct the error generated in the pressure sensors 240 and 250. The controller 600 corrects the pressure sensors 240 and 250 based on the measured pressure in a state where the fuel cell 100 communicates with the outside at S110.

When the pressure sensors 240 and 250 have been corrected based on the atmospheric pressure, the controller 600 shuts off the discharge valve 310 at S200. The controller 600 checks whether choking occurs or not after shutting off the discharge valve 310, and differently estimates the gas discharge amount discharged through the discharge line 300 depending on whether choking occurs or not at S300. The controller 600 calculates a difference between pressure measured by the hydrogen nozzle-pressure sensor 240 and pressure measured by the hydrogen low-pressure sensor 250 so as to check whether choking occurs or not after shutting off the discharge valve 310 at S310, and compares the calculated difference with the reference value at S320. The controller 600 determines that choking occurs when the calculated difference is larger than the reference value at S330, and determines that no choking occurs when the calculated difference is smaller than the reference value at S340.

When choking occurs, the controller 600 calculates the hydrogen supply amount based on pressure measured by the hydrogen nozzle-pressure sensor 240. When no choking occurs, the controller 600 calculates the hydrogen supply amount based on the pressure measured by the hydrogen nozzle-pressure sensor 240 and the hydrogen low-pressure sensor 250. The controller 600 differently estimates the gas discharge amount using the hydrogen supply amount that is differently calculated depending on whether choking occurs (S330, S340).

Subsequently, when the gas discharge amount has been estimated, the controller 600 checks whether the pressure sensors 240 and 250 corrected based on the atmospheric pressure are maintained in the normal state at S400. When the pressure sensors 240 and 250 are maintained in the normal state, the controller 600 estimates the gas discharge amount while the pressure sensors 240 and 250 are maintained in the normal state, calculates and stores the average value of the estimated gas discharge amount at S410. Since the maintenance of the pressure sensors 240 and 250 in the normal state means that no error occurs in the measured values of the pressure sensors 240 and 250, the controller 600 needs to estimate the gas discharge amount when no error occurs in the pressure sensors 240 and 250. However, when estimating the gas discharge amount, the gas discharge amount is differently estimated depending on whether the previously determined choking occurs. Therefore, the controller 600 needs to calculate and store the average value of the calculated gas discharge amount depending on whether choking occurs. Thereafter, when an error occurs in the pressure sensors 240 and 250, the controller 600 may determine a degree in which an error occurs, based on the estimated gas discharge amount in the normal state.

When the pressure sensors 240 and 250 corrected based on the atmospheric pressure are not maintained in the normal state, the controller 600 estimates the gas discharge amount in a state where the sensors are not maintained in the normal state. Further, the controller 600 calculates a difference in the average value between the estimated gas discharge amount in the abnormal state and the stored gas discharge amount in the normal state at S500. Subsequently, the controller 600 differently corrects the pressure sensors 240 and 250 depending on whether choking occurs, based on the calculated difference at S600.

Even in the step S500 of calculating the difference in the average value of the gas discharge amount, the controller 600 calculates a difference depending on whether choking occurs, using the average value of the gas discharge amount that is differently calculated depending on whether the choking occurs. In the steps S510 and S520 in which the controller 600 calculates a difference value and then calculates a correction value, it may be differently applied depending on whether choking occurs.

When choking occurs, the controller 600 calculates the correction value of the hydrogen nozzle-pressure sensor 240 to correct the hydrogen nozzle-pressure sensor 240. When no choking occurs, the controller 600 calculates the correction value of the hydrogen low-pressure sensor 250 to correct the hydrogen low-pressure sensor 250. To be more specific, when choking occurs, the controller 600 calculates the correction value of the hydrogen nozzle-pressure sensor 240 based on the calculated difference at S510. The calculated correction value is a measurement error occurring in the hydrogen nozzle-pressure sensor 240, and the controller 600 corrects the hydrogen nozzle-pressure sensor 240 using the calculated correction value at S610. When no choking occurs, the controller 600 calculates the correction value of the hydrogen low-pressure sensor 250 based on the calculated difference and the pressure measured by the hydrogen nozzle-pressure sensor 240 at S520. The calculated correction value is a measurement error occurring in the hydrogen low-pressure sensor 250, and the controller 600 corrects the hydrogen low-pressure sensor 250 using the calculated correction value at S620.

Thereby, when the measurement error occurs after the hydrogen nozzle-pressure sensor 240 and the hydrogen low-pressure sensor 250 are corrected based on the atmospheric pressure, the measurement error of the hydrogen nozzle-pressure sensor 240 and the hydrogen low-pressure sensor 250 may be corrected using internal factors without making the fuel cell 100 communicate with the outside.

As described above, the present disclosure provides a hydrogen supply system for a fuel cell and a control method thereof, in which a pressure sensor is corrected based on an estimated gas discharge amount after a discharge valve is shut off during the operation of the fuel cell, thus preventing the concentration of hydrogen from being reduced due to the communication of the fuel cell with the outside, and preventing the fuel cell from being deteriorated.

Further, the present disclosure provides a hydrogen supply system for a fuel cell and a control method thereof, in which a pressure sensor is corrected based on a gas discharge amount that is differently estimated depending on whether choking occurs after a discharge valve is shut off, thus preventing the hydrogen concentration of a fuel cell from being excessively increased or reduced due to the measurement error of the pressure sensor.

Although the present disclosure was described with reference to specific embodiments shown in the drawings, it is apparent to those skilled in the art that the present disclosure may be changed and modified in various ways without departing from the scope of the present disclosure, which is described in the following claims.

1. A hydrogen supply system for a fuel cell, the system comprising:
a fuel cell;
a hydrogen supply line connected to an inlet side of a fuel-cell anode, and configured to supply hydrogen to the fuel cell;
a pressure sensor provided on the hydrogen supply line, and configured to measure a pressure of the hydrogen supply line;
a discharge line connected to an outlet side of the fuel-cell anode, and communicating with an outside;
a discharge valve provided on the discharge line configured to control communication between the fuel-cell anode and the outside; and
a controller configured to shut off the discharge valve during an operation of the fuel cell, to differently estimate an amount of gas discharged through the discharge line depending on whether choking occurs after the discharge valve is shut off, and to correct the pressure sensor based on the estimated gas discharge amount.

2. The hydrogen supply system of claim 1, wherein the controller is further configured to correct the pressure sensor based on atmospheric pressure in a state where the fuel cell communicates with the outside by opening the discharge valve before the discharge valve is shut off.

3. The hydrogen supply system of claim 1, wherein the pressure sensor comprises a hydrogen nozzle-pressure sensor and a hydrogen low-pressure sensor, the hydrogen nozzle-pressure sensor being located at an upstream point of an ejector provided on the hydrogen supply line, and the hydrogen low-pressure sensor being located at a downstream point of the ejector provided on the hydrogen supply line.

4. The hydrogen supply system of claim 3, wherein the controller is further configured to calculate a difference between pressures measured through the hydrogen nozzle-pressure sensor and the hydrogen low-pressure sensor, to determine that choking occurs when the calculated difference is larger than a reference value, and to determine that no choking occurs when the calculated difference is smaller than the reference value.

5. The hydrogen supply system of claim 4, wherein the controller is further configured to calculate a hydrogen supply amount based on pressure measured by the hydrogen nozzle-pressure sensor when the choking occurs, to calculate a hydrogen supply amount based on pressure measured by the hydrogen nozzle-pressure sensor and the hydrogen low-pressure sensor when no choking occurs, and to estimate a gas discharge amount using the calculated hydrogen supply amount.

6. The hydrogen supply system of claim 5, wherein, when the gas discharge amount is estimated and then the pressure sensor corrected based on the atmospheric pressure maintains a normal state, the controller is configured to calculate an average value of the estimated gas discharge amount while the normal state is maintained, and then to store the average value in a memory.

7. The hydrogen supply system of claim 6, wherein the normal state of the pressure sensor is an initial state where no error occurs in a measured value of the pressure sensor after the pressure sensor is corrected.

8. The hydrogen supply system of claim 6, wherein the controller is further configured to calculate a difference in average value between the estimated gas discharge amount when the pressure sensor, corrected based on the atmospheric pressure after the gas discharge amount is estimated, is not maintained in the normal state and the stored gas discharge amount in the normal state.

9. The hydrogen supply system of claim 5, wherein the controller is further configured to calculate a correction value of the hydrogen nozzle-pressure sensor based on a calculated difference in average value between the estimated gas discharge amount when choking occurs and the stored gas discharge amount, and to correct the hydrogen nozzle-pressure sensor through the calculated correction value.

10. The hydrogen supply system of claim 5, wherein the controller is further configured to calculate the correction value of the hydrogen low-pressure sensor based on a calculated difference in average value between the estimated gas discharge amount when no choking occurs and the stored gas discharge amount and a pressure measured by the hydrogen nozzle-pressure sensor, and to correct the hydrogen low-pressure sensor through the calculated correction value.

11. A method of controlling a hydrogen supply system for a fuel cell, the method comprising:
shutting off a discharge valve during an operation of the fuel cell by a controller;
differently estimating a gas discharge amount discharged through a discharge line depending on whether choking occurs after the discharge valve is shut off by the controller; and
correcting a pressure sensor based on the estimated gas discharge amount depending on whether choking occurs by the controller.

12. The method of claim 11, wherein, when differently estimating the gas discharge amount, the controller calculates a difference between pressure measured by the hydrogen nozzle-pressure sensor and pressure measured by the hydrogen low-pressure sensor, determines that choking occurs when the calculated difference is larger than a reference value, and determines that no choking occurs when the calculated difference is smaller than the reference value.

13. The method of claim 12, wherein, when differently estimating the gas discharge amount, the controller calculates a hydrogen supply amount based on pressure measured by the hydrogen nozzle-pressure sensor when choking occurs, calculates the hydrogen supply amount based on the pressure measured by the hydrogen nozzle-pressure sensor and the hydrogen low-pressure sensor when no choking occurs, and estimates the gas discharge amount using the calculated hydrogen supply amount.

14. The method of claim 12, wherein, when correcting the pressure sensor, the controller calculates the correction value of the hydrogen nozzle-pressure sensor to correct the hydrogen nozzle-pressure sensor, when choking occurs.

15. The method of claim 12, wherein, when correcting the pressure sensor, the controller calculates the correction value of the hydrogen low-pressure sensor to correct the hydrogen low-pressure sensor, when no choking occurs.
